(19) United States
(12) Patent Application Publication
(10) Pub. No.: US 2015/0155063 A1
(43) Pub. Date: Jun. 4, 2015

(54) REACTOR POWER STABILITY MONITORING SYSTEM AND A REACTOR POWER STABILITY MONITORING METHOD

(71) Applicant: Kabushiki Kaisha Toshiba, Minato-ku (JP)

(72) Inventor: Shigehiro KONO, Tama (JP)

(73) Assignee: Kabushiki Kaisha Toshiba, Minato-ku (JP)

(21) Appl. No.: 14/556,809

(22) Filed: Dec. 1, 2014

(30) Foreign Application Priority Data
Dec. 4, 2013 (JP) 2013-250726

(51) Int. Cl. G21C 17/00

(52) U.S. Cl. CPC G21C 17/00

(57) ABSTRACT

An embodiment of a reactor power stability monitoring system has: a time averaging unit that calculates a time average value of the local neutron flux signals; a harmonic wave difference calculation unit that extracts, as an AC component signal, a difference between the local neutron flux signal and the time average value calculated by the time averaging unit; a low-pass filter that performs low-pass filtering of the AC component signal; a down-sampling unit that down-samples a low-frequency alternate current component signal that has passed through the low-pass filter, at intervals that are longer than the detection sampling intervals and shorter than the averaging time and that are shorter than or equal to intervals (necessary to detect oscillation inside the core; and a Fourier transform unit that performs Fourier transformation of the down-sampled low-frequency AC component signal to output a frequency spectral density distribution.

### CROSS-REFERENCE TO RELATED APPLICATION

This application is based upon and claims the benefit of priority from Japanese Patent Application No.2013-250726 filed on Dec. 4, 2013, the entire content of which is incorporated herein by reference.

### FIELD

Embodiments described herein relate generally to a reactor power stability monitoring system and a reactor power stability monitoring method.

### BACKGROUND

A reactor power stability monitoring system of a conventional boiling water reactor monitors an average value of power of a neutron detector (an average value of a local reactor power) which is installed in such away as to surround part of fuel assemblies inside a reactor.

As such a reactor power stability monitoring system, an Oscillation Power Range Monitor (OPRM) system is available as described in Japanese Patent No. 3,064,084.

As for stability of reactor power of the boiling water reactor, there are two aspects: temporal fluctuation of neutron flux of an entire fuel loading area of the reactor, and local oscillation of the reactor power, as described in IAEA-TECDOC-1474, IAEA, November 2005.

Moreover, it is possible to monitor the instability of the reactor power by checking whether or not there is a harmonic wave in power spectral density that is obtained by performing Fourier transformation of a reactor power signal, as disclosed in Japanese Patent No. 2,838,002 and Japanese Patent No. 3,847,988. However, there are no reports describing a specific method of monitoring unstable events of the reactor power.

Plenty of researches have been conducted on the stability of the boiling water reactor. It is known that local oscillation of the reactor power occurs due to an unstable state of thermal hydraulic characteristics, and that oscillation of the entire reactor occurs due to nuclear characteristics.

The unstable state of thermal hydraulic characteristics is caused by a difference in coolant density between lower and upper portions of a reactor core. In order to detect such oscillation, the output of the lower portion and the output of the upper portion of the same fuel channel need to be separately monitored. The reason why the oscillation associated with nuclear characteristics occurs may be that, if an unstable area of thermal hydraulic characteristics exists locally, a power distribution of a higher-order mode occurs at symmetrical positions in the core as a maximum amplitude point, and the distribution continues to exist without attenuating.

To determine whether or not the higher-order mode core power distribution exists, the confirmation can be made by creating a power distribution curve using an output signal of the neutron detector disposed on a plane that contains the center of the core and locally unstable areas. However, the locally unstable areas may not exist on both sides of the core's center in such a way as to be horizontally symmetrical, and the plane may be inclined from the horizontal plane.

However, as pointed out by aforementioned IAEA-TECDOC, the current Oscillation Power Range Monitor (OPRM) system is designed to monitor the local power of the reactor by averaging in a vertical direction. Therefore, the problem is that the system cannot monitor the oscillation of the axial power distribution of the reactor power. Moreover, since only the locally averaged power is monitored, it is difficult to accurately detect the power oscillation of the reactor entirely.

Furthermore, it is difficult to predict in advance the slope of the plane that characterizes the unstable state of nuclear characteristics. To monitor the degree of instability of the reactor power associated with nuclear characteristics, it is insufficient to monitor only the fluctuation of the reactor power on a limited level plane by using existing Local Power Range Monitor (LPRM) detectors installed at four different heights (Levels A, B, C, and D) in the axis direction of the core.

### BRIEF DESCRIPTION OF THE DRAWINGS

FIG. 1 is a block diagram showing the configuration of a reactor power stability monitoring system according to an embodiment;

FIG. 2 is a flowchart showing a flow of monitoring a harmonic wave or the like according to the reactor power stability monitoring method according to the embodiment;

FIG. 3 is a chart showing a change over time of an LPRM detector signal that is sampled by the detection sampling unit;

FIG. 4 is a chart showing a change over time of the signal after the down-sampling;

FIG. 5 is a spectrum diagram showing a frequency spectral density distribution at a time when FFT is performed on the LPRM detector signal that is sampled by the detection sampling unit;

FIG. 6 is a spectrum diagram showing a frequency spectral density distribution that is obtained by performing FFT on the down-sampled signal;

FIG. 7 is a diagram showing the state of the reactor power distribution having second-order distribution mode; and

FIG. 8 is a diagram showing the results of calculation of the squares of the differences in the case of the reactor power having second-order distribution mode.

### DETAILED DESCRIPTION

Embodiments of the present invention have been made to solve the above problems. The object of the embodiments of the present invention is to monitor in real time the overall oscillation of the reactor power and the local oscillation thereof by using signal of neutron detectors of conventional power range monitoring system.

According to an embodiment, there is provided a reactor power stability monitoring system that monitors oscillation of power of a reactor in real time based on a local neutron flux signal obtained by sampling, at predetermined detection sampling intervals, a signal from a plurality of neutron detectors arranged in a reactor core, the system comprising: a time averaging unit that calculates a time average value of the local neutron flux signals by taking into account a cycle of steady-state fluctuation, a time average value being a time average over a predetermined averaging time, a harmonic wave difference calculation unit that extracts, as an AC component signal, a difference between the local neutron flux signal and the time average value calculated by the time averaging unit, a low-pass filter that performs low-pass filtering of the AC component signal, a down-sampling unit that down-samples a low-frequency AC component signal that has passed through the low-pass filter, at intervals that are longer than the detection sampling intervals and shorter than the averaging time and that are shorter than or equal to intervals necessary to detect oscillation in the core, and a Fourier transform unit that performs Fourier transformation of the down-sampled low-frequency AC component signal to output a frequency spectral density distribution.

According to another embodiment, there is provided a reactor power stability monitoring method that monitors in real time oscillation of power of a reactor based on a local neutron flux signal obtained by sampling, at predetermined detection sampling intervals, a signal from a plurality of neutron detectors arranged inside a core of the reactor, the method comprising: a time averaging step by a time averaging unit of calculating a time average value over a predetermined averaging time of the local neutron flux signals, a harmonic wave difference calculation step by a harmonic wave difference calculation unit of extracting, as an AC component signal, a difference between the local neutron flux signal and the time average value, a low-pass filtering step by a low-pass filter of performing low-pass filtering of an AC component signal, a down-sampling step by a down-sampling unit of down-sampling at intervals that are longer than the detection sampling intervals and shorter than the averaging time and which are greater than intervals necessary to detect oscillation in the core, and a Fourier transformation step by a Fourier transform unit of performing Fourier transformation of the down-sampled low-frequency. AC component signal to output a frequency spectral density distribution.

Hereinafter, with reference to the accompanying drawings, a reactor power stability monitoring system and a reactor power stability monitoring method of an embodiment of the present invention will be described. Here, the same or similar portions are represented by the same reference symbols, and will not be described again.

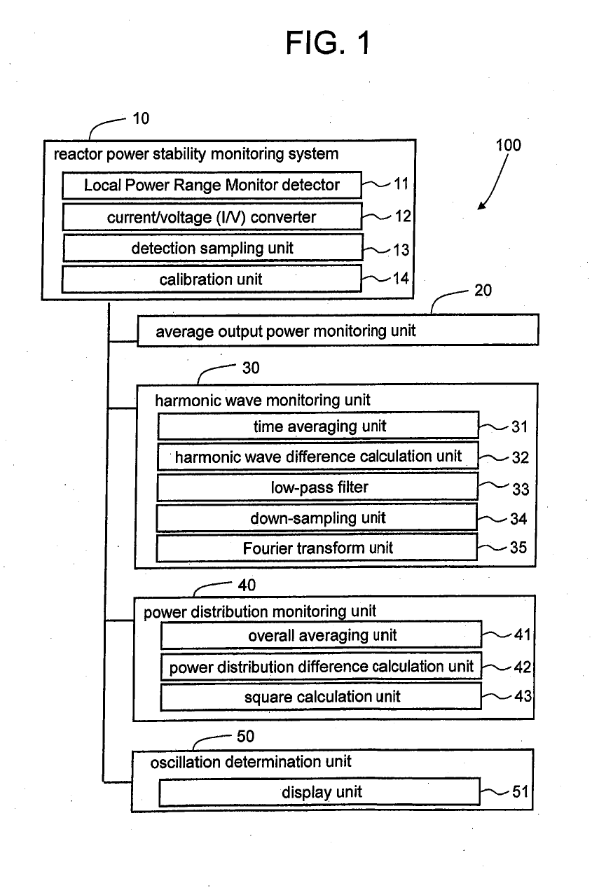

FIG. 1 is a block diagram showing the configuration of a reactor power stability monitoring system according to the embodiment. A reactor power stability monitoring system 100 includes: a local power monitoring unit 10, which monitors a local power of a reactor; an average power monitoring unit 20, which monitors an average power of an entire core; a harmonic wave monitoring unit 30, which monitors a harmonic wave component; a power distribution monitoring unit 40, which monitors the deviation of the power distribution in the core; and an oscillation determination unit 50.

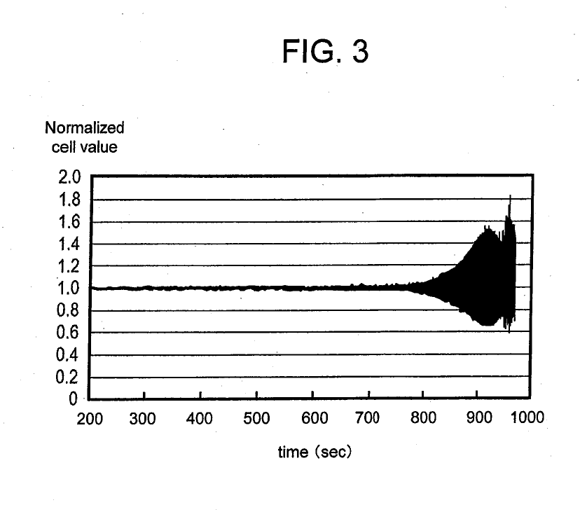

The local power monitoring unit 10 includes: a plurality of Local Power Range Monitor (LPRM) detectors 11; a current/voltage (I/V) converter 12, which converts a current output signal of the LPRM detectors 11 to a voltage signal; a detection sampling unit 13, which samples an LPRM detector signal that has been converted to voltage signal at predetermined detection sampling intervals; and a calibration unit 14, which multiplies each local neutron flux signal which has been sampled, by an LPRM gain. FIG. 3 is a chart showing a change over time of an LPRM detector signal that is sampled by the detection sampling unit. In FIG. 3 the LPRM signal is illustrated in normalized cell value. In this case, the LPRM detector signal is sampled every 250 milliseconds; the collection of 1,024 data items requires 256 seconds (equal to 4 minutes 16 seconds).

The average power monitoring unit 20 calculates an average power of the core by averaging all local neutron flux signals and multiplying by an Average Power Range Monitor (APRM) gain, and outputs the average power to the oscillation determination unit 50.

The harmonic wave monitoring unit 30 includes a time averaging unit 31, a harmonic wave difference calculation unit 32, a low-pass filter 33, a down-sampling unit 34, and a Fourier transform unit 35. The time averaging unit 31 calculates a time average value of the local neutron flux signal over a predetermined period of time. The harmonic wave difference calculation unit 32 extracts a difference between the time average value calculated by the time averaging unit 31 and the local neutron flux signal as alternate current component.

The low-pass filter 33 allows low-frequency alternate current component signal that is lower than a local oscillation frequency range in the core to pass therethrough, among the alternate current components extracted by the harmonic wave difference calculation unit 32. The low-pass filter 33 makes high-frequency alternate current component signal that is higher than the oscillation frequency range to attenuate. In this case, the local oscillation frequency range in the core is a range of about 0.2 Hz.

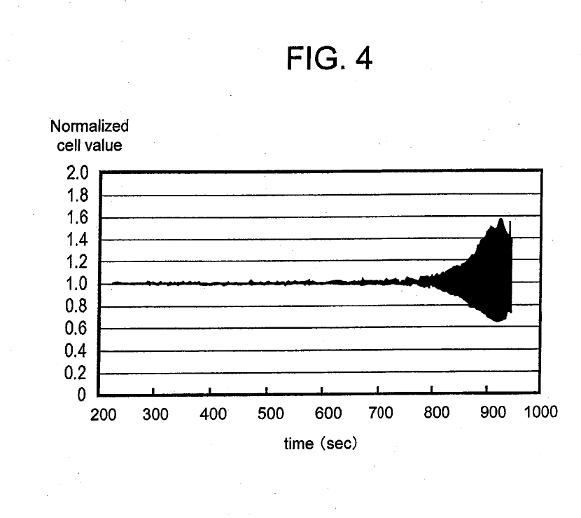

The down-sampling unit 34 down-samples the low-frequency alternate current component signal that has passed through the low-pass filter 33. In the following, the term of “down-sampling” means to sample at intervals that are longer than the detection sampling intervals of the sampling by the detection sampling unit 13 of the local power monitoring unit 10 and that are shorter than or equal to the intervals necessary to detect the oscillation in the core. As a result, the high-frequency alternate current component signal that has attenuated in the low-pass filter 33 is removed. FIG. 4 is a chart showing a change over time of the signal after the down-sampling. In FIG. 4 the LPRM signal is illustrated in normalized cell value. In the example shown in FIG. 4, the down-sampling is conducted at sampling intervals of 4 seconds (Sampling frequency=0.25 Hz). As a result, the number of data items is compressed from 1,024 to 64.

The Fourier transform unit 35 performs Fast Fourier Trans formation of the down-sampled low-frequency alternate current component digitally, or performs digital Fourier transformation. The Fourier transform unit 35 then outputs a frequency spectral density distribution to the oscillation determination unit 50. The oscillation determination unit 50 monitors the change of a harmonic wave component based on the frequency spectral density distribution.

The power distribution monitoring unit 40 includes an overall averaging unit 41, a power distribution difference calculation unit 42, and a square calculation unit 43. The overall averaging unit 41 receives, as inputs, a local neutron flux signals that are output from the calibration unit 14 of the local power monitoring unit 10, and then calculates a core overall average value, which is the overall average (spatial average) of the local neutron flux signals in the entire core.

The power distribution difference calculation unit 42 extracts each of the differences between the average value calculated by the overall averaging unit 41 and the local neutron flux signals. The square calculation unit 43 calculates the squares of the differences, and calculates the average value of the squares in the entire core to output to the oscillation determination unit 50.

The oscillation determination unit 50 monitors whether an abnormality occurs or not in the change of the harmonic wave component by receiving outputs from the average power monitoring unit 20, the harmonic wave monitoring unit 30, and the power distribution monitoring unit 40. The oscillation determination unit 50 includes a display unit 51 to display online the outputs from the average power monitoring unit 20, the harmonic wave monitoring unit 30, and the power distribution monitoring unit 40. The display unit 51 includes a warning function to issue a warning at a time when the abnormality occurs.

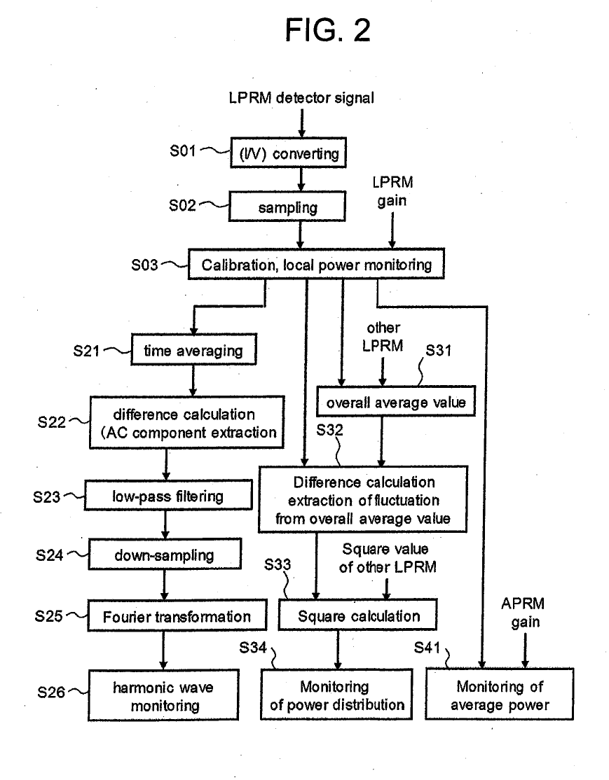

FIG. 2 is a flowchart showing a flow of monitoring a harmonic wave or the like according to the reactor power stability monitoring method according to the embodiment. To the LPRM detectors 11, for example, a DC voltage of 100V is applied; the LPRM detectors 11 output current signals that are proportional to neutron flux density. The I/V converter 12 converts the current signals supplied from the LPRM detectors 11 into voltage signals through current/voltage conversion (I/V conversion) (Step S01). Then, the detection sampling unit 13 samples the LPRM detector signal, which has been converted to the voltage signal, at predetermined detection sampling intervals (Step S02). The sensitivity of the LPRM detectors 11 varies according to irradiation of neutrons. Therefore, the calibration unit 14 multiplies the sampled local neutron flux signal by the LPRM gain to obtain a local neutron flux signal corresponding to the neutron density (J/m²). Then, the local neutron flux signal multiplied by the LPRM gain is monitored (Step S03).

A procedure pertaining to a harmonic wave monitoring step will be described. The time averaging unit 31 calculates a time average value over a predetermined period of time of the local neutron flux signals (Step S21). Usually, the LPRM detector signal contains, as about 2% of the output for example, a component of fluctuation with a frequency of about several tens of seconds that occurs as air bubbles associated with boiling of the coolant pass near the detectors. Therefore, in order to obtain the time average value of each LPRM signal, the signals are averaged over about several minutes.

Then, the harmonic wave difference calculation unit 32 extracts, as an alternate current component, the difference between the time average value of the signals, which has been calculated by the time averaging unit 31 over several minutes, and the local neutron flux signal (Step S22). The alternate current component extracted by the harmonic wave difference calculation unit 32 is input to the low-pass filter 33. The low-pass filter 33 allows a low-frequency alternate current component signal that is lower than a local oscillation frequency range in the core to pass therethrough, while making a high-frequency alternate current component signal that is higher than the oscillation frequency range to attenuate (Step S23). In this case, a cutoff frequency of the low-pass filter 33 is set in such a way as to filter the frequency of a high-order mode harmonic wave that should be grasped with a sufficient margin.

The down-sampling unit 34 down-samples the low-frequency alternate current component signal that has passed through the low-pass filter 33, at intervals that are longer than the detection sampling intervals of the sampling by the detection sampling unit 13 of the local power monitoring unit 10 (Step S24). As a result, the high-frequency alternate current component signal that has attenuated in the low-pass filter 33 is removed. That is, if the down-sampling is performed at intervals of Td, frequency fd is: fd=1/Td. A frequency component that is less than or equal to fd/2 remains as a meaningful component, and a frequency component that is greater than fd/2 is removed.

The Fourier transform unit 35 performs digital Fourier transformation of the low-frequency alternate current component that is down-sampled by the down-sampling unit 34, and outputs a frequency spectral density distribution to the oscillation determination unit 50 (Step S25).

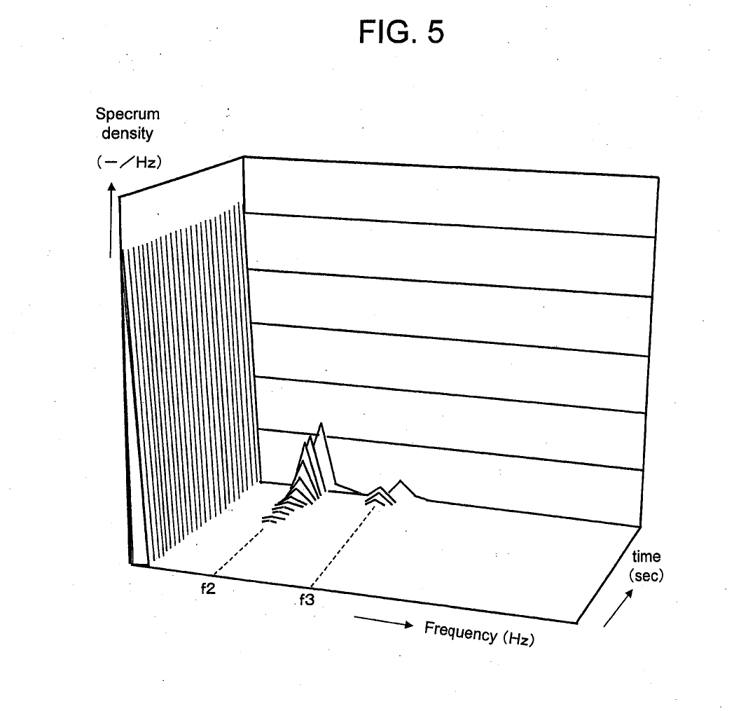

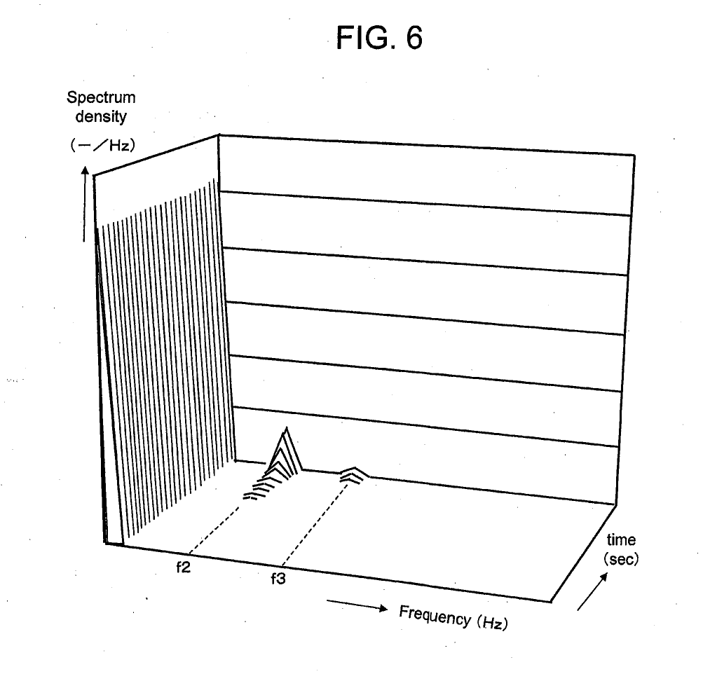

FIG. 5 is a spectrum diagram showing a frequency spectral density distribution in the case that FFT is performed on the LPRM detector signal that is sampled by the detection sampling unit. FIG. 6 is a spectrum diagram showing a frequency spectral density distribution that is obtained by performing FFT on the down-sampled signal.

The harmonic wave difference calculation unit 32 regards the difference between each of the data items and the average value of the 1,024 date items in the case where the LPRM detector signal is sampled by the detection sampling unit 13 at intervals of 250 milliseconds, as an alternate current component signal for the period of 4 minutes 16 seconds (0.25 seconds×1,024). If the Fourier transform unit 35 performs 1,024^{th}-order Fourier transformation using the 1,024 alternate current component signals, a frequency spectral density distribution map for the period of 4 minutes 16 seconds is obtained as shown in FIG. 5. As shown in FIG. 5, the component of frequency f2 corresponding to second-order mode is generated and gradually increases. It is also clear that, after the component of f2 is generated, the component of frequency f3 corresponding to third-order mode is generated.

Meanwhile, for example, the frequency of the higher-order harmonic wave component is as high as about 0.1 Hz. Therefore, the low-pass filter 33 performs a low-pass filtering process with a cutoff frequency of 0.125 Hz on the 1,024 alternate current component signals, and carries out down-sampling at sampling intervals of four seconds (Down-sampling frequency=0.25 Hz). If the number of data items is compressed from 1,024 to 64 as described above, as shown in FIG. 6, it is clear that the component of frequency f2 corresponding to second-order mode is generated and gradually increases, and that, after the component of f2 is generated, the component of frequency f3 corresponding to third-order mode is generated. In this manner, the frequency spectral density distribution map that is obtained by performing 64^{th}-order Fourier transformation using the 64 data items provides the same amount of information as the frequency spectral density distribution map that is obtained from the 1,024 data items.

That is, even if a low-pass filtering process is performed in such a way as to at least allow main higher-order mode harmonic waves such as second-order or third-order mode to pass therethrough while cutting the harmonic waves corresponding to higher-order modes, there is practically no impact on the frequency spectrum. In this manner, the low-pass filtering is carried out, and then the number of signals that are to be processed is reduced by down-sampling. Then, by low-order Fourier transformation, signal processing is carried out at high-speed. Therefore, it is possible to monitor, in real time, the occurrence of harmonic waves of the reactor power oscillation, amplification, and the occurrence of higher-order harmonic waves.

The oscillation determination unit 50 continues to monitor harmonic waves based on the frequency spectral density distribution output from the harmonic wave monitoring unit 340 (Step S26). The frequency spectral density distribution maps are displayed on the display unit 51 in chronological order. By arranging the frequency spectral. density distribution maps in chronological order for comparison, it is possible to visually understand the occurrence of harmonic wave components, amplification, and the occurrence of higher-order harmonic wave components at a time when local oscillation of the reactor power occurs at the positions of the LPRM detectors 11.

More specifically, the oscillation determination unit 50 scans data of the frequency spectral density distribution. When a frequency component that is different from a frequency of fluctuation during normal operation emerges, the oscillation determination unit 50 records the frequency. The oscillation determination unit 50 monitors whether or not the component of the same frequency is observed, and whether or not the value of the component of the same frequency increases, in the temporally continuous frequency spectral density distribution data items. Or the oscillation determination unit 50 assumes that the observed frequency component is the second-order harmonic wave, and monitors whether or not signals of frequencies (1.5 and 2 times as large) corresponding to third- and fourth-order harmonic waves emerge following the occurrence of second-order harmonic waves. After that, if the components of second-order harmonic waves have increased, or if new signals of frequencies that are 1.5 and 2 times as large as the frequency have emerged, it is determined that a local oscillation phenomenon of the reactor-power has occurred, and the determination result is displayed on the display unit 51.

Moreover, based on the determination result, the oscillation determination unit 50 may generate a selection control rod insertion signal for a reactor protection system to control the reactor power, for example.

A procedure pertaining to a power distribution monitoring step will be described. The overall averaging unit 41 receives, as an input, a local neutron flux signal that is output from the calibration unit 14 of the local power monitoring unit 10. And the overall averaging unit 41 calculates an overall average value of the local neutron flux signals in the entire core (Step S31). Then, the power distribution difference calculation unit 42 extracts each of the differences between the overall average value calculated by the overall averaging unit 41 and the local neutron flux signals (Step S32). Based on the differences, the square calculation unit 43 calculates the squares of the differences, and calculates the average value of the squares in the entire core to output to the oscillation determination unit 50 (Step S33). The oscillation determination unit 50 receives the output from the power distribution monitoring unit 40 to monitor whether or not harmonic waves exist, makes a determination as to whether or not oscillation occurs. Then the display unit 51 displays the result.

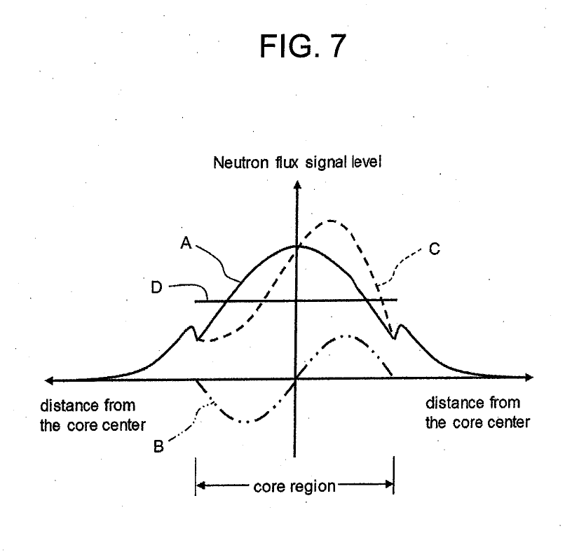

FIG. 7 is a diagram showing the state of the reactor power distribution having second-order distribution mode. Curve A of solid line in FIG. 7 represents the distribution of radial-direction neutron flux in the core during steady state in which no oscillation occurs. Curve B of two-dot chain line represents the distribution associated with second-order oscillation mode at a certain moment. Curve C of broken line represents the distribution that is made by superimposing the distribution of second-order oscillation mode of the curve B on the distribution of the curve A. Straight line D represents an average level of radial-direction neutron flux distributions.

Here, take a look into the case where, with the central axis of the core as a center, the absolute value of an increase in an increasing side of the second-order mode distribution is equal to the absolute value of a decrease in a decreasing side, and only the signs are different. In this case, the average of the distribution of the curve C on which the second-order mode is superimposed is equal in level to the average during steady state, or to the average of the distribution of the curve A. That is, in the case of even-order distribution mode in which the central axis of the core is a nodal point of oscillation, there are the same number of peaks and troughs of the distribution. Therefore, the peaks and troughs are cancelled by each other when simple averaging is carried out. As a result, even when oscillation occurs, the average value remains unchanged. In this manner, when the average is simply calculated, it is difficult to understand the even-order mode.

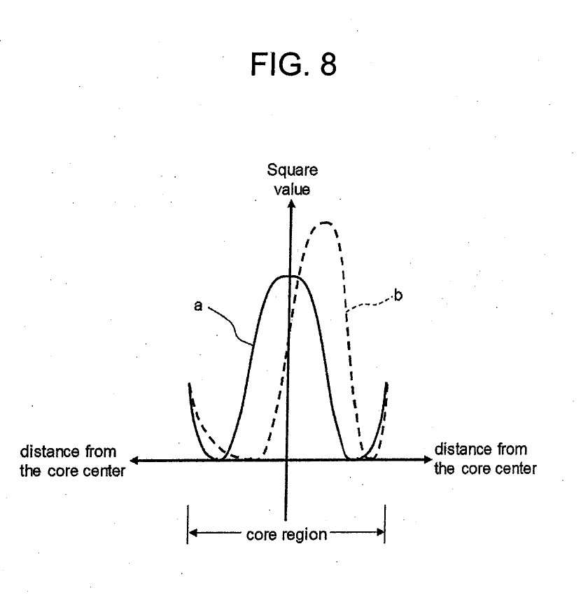

FIG. 8 is a diagram showing the results of calculation of the squares of the differences in the case of the reactor power having second-order distribution mode. Curve “a” of solid line represents the distribution of the squares of the differences between the average value and the distribution of curve “A” in. FIG. 7, i.e. in the case of the distribution of steady state. Curve “b” of broken line represents the distribution of the squares of the differences between the average value and the distribution of curve “C” in FIG. 7, i.e. in the case of the distribution on which the second-order mode is superimposed. In this manner, the disturbance of the power distribution in the core can be determined by measuring using the average of the squares of the differences with respect to the average value in the entire reactor of the outputs of a plurality of LPRM detectors 11 disposed evenly in the entire core. By monitoring the average of the squares of the differences with respect to the average value, it is possible to monitor the magnitude of oscillation (randomness of the reactor power).

Meanwhile, the average power monitoring unit 20 calculates an average power of the core by averaging all local neutron flux signals and multiplying by an Average Power Range Monitor (APRM) gain, and outputs the average power to the oscillation determination unit 50. The oscillation determination unit 50 monitors the change of the average power of the core that is multiplied by the Average Power Range Monitor (APRM) gain (Step S41).

The amplification of the oscillation of the core power occurs when the percentage of the amplification is larger due to a difference between the time constants of attenuation and the time constants of amplification. Therefore, the average value of the core power gradually increases, too. Therefore, a conventional Average Power Range Monitor (APRM) system, too, is effective as a means to monitor the occurrence of oscillation of the core power. For example, conventionally, the monitoring is performed to check whether or not the value has reached high level of a reactor power, which is a level at which a warning is to be issued, and whether or not the value has reached high-high level of a reactor power, which is a higher level at which a reactor trip signal is to be issued. Here, a new third setting value is set, and a selection control rod insertion signal is generated when the reactor average power exceeds the third setting value. Therefore, it is possible to enable oscillation of the reactor power, as well as to control the oscillation.

As described above, according to the present embodiment, by performing the filtering and down-sampling of the neutron flux signals, the signal processing can be performed at high speed, and the occurrence of harmonic waves and the state of the change can be monitored in real time.

Moreover, by monitoring the distribution of the squares of the differences with respect to the average value of the core's neutron flux distributions, it is possible to understand the magnitude of the change from the steady state in a simple manner.

As described above, according to the present embodiment, by using a signal of a neutron detector of a conventional reactor power range neutron monitoring system, it is possible to monitor the overall and local oscillation of the reactor power in real time.

### Other Embodiments

The embodiment of the present invention has been described above. However, the embodiment is described above only as an exemplar embodiment without any intention of limiting the scope of the present invention.

Furthermore, the above-described embodiment may be put to use in various different ways and, if appropriate, any of the components thereof may be omitted, replaced or altered in various different ways without departing from the spirit and scope of the invention.

Therefore, all the above-described embodiments and the modifications made to them are within the spirit and scope of the present invention, which is specifically defined by the appended claims, as well as their equivalents.

What is claimed is:

1. A reactor power stability monitoring system that monitors oscillation of power of a reactor in real time based on a local neutron flux signal obtained by sampling, at predetermined detection sampling intervals, a signal from a plurality of neutron detectors arranged in a reactor core, the system comprising:
a time averaging unit that calculates a time average value of the local neutron flux signals by taking into account a cycle of steady-state fluctuation, a time average value being a time average over a predetermined averaging time,
a harmonic wave difference calculation unit that extracts, as an AC component signal, a difference between the local neutron flux signal and the time average value calculated by the time averaging unit,
a low-pass filter that performs low-pass filtering of the AC component signal,
a down-sampling unit that down-samples a low-frequency AC component signal that has passed through the low-pass filter, at intervals that are longer than the detection sampling intervals and shorter than the averaging time and that are shorter than or equal to intervals necessary to detect oscillation in the core, and
a Fourier transform unit that performs Fourier transformation of the down-sampled low-frequency AC component signal to output a frequency spectral density distribution.

2. The reactor power stability monitoring system according to claim 1, further comprising
an oscillation determination unit that determines, if a frequency component that is different from a frequency of a fluctuation component during normal operation is detected in the frequency spectral density distribution obtained as a result of the Fourier transformation, whether spectral density of the frequency becomes greater than normal, and determines, if a spectral density signal of a frequency 1.5 or 2 times as large as the frequency is observed, that a local unstable event in the power of the reactor has occurred.

3. The reactor power stability monitoring system according to claim 1, further comprising:
an overall averaging unit that calculates an entire-core average value of the local neutron flux signals,
a power distribution difference calculation unit that extracts a difference with respect to the entire-core average value of the local neutron flux signals, and
a square calculation unit that calculates squares of the differences extracted by the power distribution difference calculation unit, and calculates a sum of the squares across an entire region of the core.

4. The reactor power stability monitoring system according to claim 1, further comprising
a display unit that displays distribution maps of frequency spectral density in chronological order.

5. A reactor power stability monitoring method that monitors in real time oscillation of power of a reactor based on a local neutron flux signal obtained by sampling, at predetermined detection sampling intervals, a signal from a plurality of neutron detectors arranged inside a core of the reactor, the method comprising:
a time averaging step by a time averaging unit of calculating a time average value over a predetermined averaging time of the local neutron flux signals,
a harmonic wave difference calculation step by a harmonic wave difference calculation unit of extracting, as an AC component signal, a difference between the local neutron flux signal and the time average value,
a low-pass filtering step by a low-pass filter of performing low-pass filtering of an AC component signal,
a down-sampling step by a down-sampling unit of down-sampling at intervals that are longer than the detection sampling intervals and shorter than the averaging time and which are greater than intervals necessary to detect oscillation in the core, and
a Fourier transformation step by a Fourier transform unit of performing Fourier transformation of the down-sampled low-frequency AC component signal to output a frequency spectral density distribution.

6. A reactor power stability monitoring method according to claim 5, further comprising:
an overall averaging step by an overall averaging unit of calculating an entire-core average value of the local neutron flux signals,
a power distribution difference calculation step by a power distribution difference calculation unit of extracting a difference with respect to the entire-core average value of the local neutron flux signals, and
a square calculation step by a square calculation unit of calculating squares of the differences extracted by the power distribution difference calculation unit, and calculates a sum of the squares across an entire region of the core.
